(19) United States
(12) Patent Application Publication
(10) Pub. No.: US 2025/0186276 A1
(43) Pub. Date: Jun. 12, 2025

(54) Wheelchair Attachment For Locomotion

(71) Applicant: Eric Quintana, Edinburg, TX (US)

(72) Inventor: Eric Quintana, Edinburg, TX (US)

(21) Appl. No.: 18/536,456

(22) Filed: Dec. 12, 2023

(51) Int. Cl. A61G 5/02; A61G 5/10

(52) U.S. Cl. CPC A61G 5/025; A61G 5/023; A61G 5/1054

(57) ABSTRACT

A wheelchair attachment for locomotion designed to allow a user with one arm to operate the wheelchair. The wheelchair attachment comprises of a wheel adapter and two single arms which may be connected to each other with a spring-loaded cylindrical handle sleeve. The length of the arms may be adjusted to suit the needs of the user.

### PRIOR ART

While there has been various prior art which uses levers or handles for wheelchair locomotion such as U.S. Pat. Nos. 6,820,885, 10,940,063, and US 2016/0015580, the present subject matter relates to a wheelchair attachment which allows the user to mechanically operate the wheelchair with a single arm.

### BACKGROUND OF THE INVENTION

The standard wheelchair on the market requires both hands to maneuver in all directions. Patients who have hemiplegia require caregiver assistance or use of their hand and foot in a shuffling pattern to propel themselves.

Electronic wheelchairs are another option but are not available to all due to insurance limitations, financing, and cognitive impairments. The present subject matter allows the user to convert the average wheelchair into something that may be operated with a single arm.

### SUMMARY OF THE INVENTION

the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The present subject matter comprises of a universal wheel attachment 5 that allows it to be attached to most common wheelchair models using a U-Bolt 15 or J Hook mounting system to securely hold the device to the wheel 20.

The wheelchairs may be steered by alternating the direction of the arm movement and thus driving the wheels in opposite directions. The system further allows the user to operate both actuator arms at once using only one hand, by employing a connecting cross bar/spring-loaded cylindrical handle sleeve that may be deployed through the gap between the handles and into the second handle.

The present subject matter also contemplates other means to removably couple the actuator arms to each other. In some embodiments a spring-loaded cylindrical sleeve 10 is able to connect the two actuating arms together for the user to operate with a single arm.

This Bridge then allows the user to propel the wheelchair in either a forward or backward direction on both handles simultaneously.

In some embodiments, the handles may be extended or retracted to accommodate easier access to the chair or easier egress from the chair. The adjustable arm length also helps accommodate users of different sizes.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation.

The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

Applicant has made this disclosure with respect to the current state of the art, but also contemplates advancements and that adaptations in the future may take into consideration of those advancements, namely in accordance with the then current state of the art.

It is intended that the scope of the invention be defined by the Claims as written and equivalents as applicable. Reference to a claim element in the singular is not intended to mean “one and only one” unless explicitly so stated.

### BRIEF DESCRIPTION OF DRAWINGS

FIG. 1 shows a side view of the wheelchair attachment for locomotion.

FIG. 2 shows a front perspective view of the wheelchair attachment for locomotion.

FIG. 3 shows a back perspective view of the wheelchair attachment for locomotion.

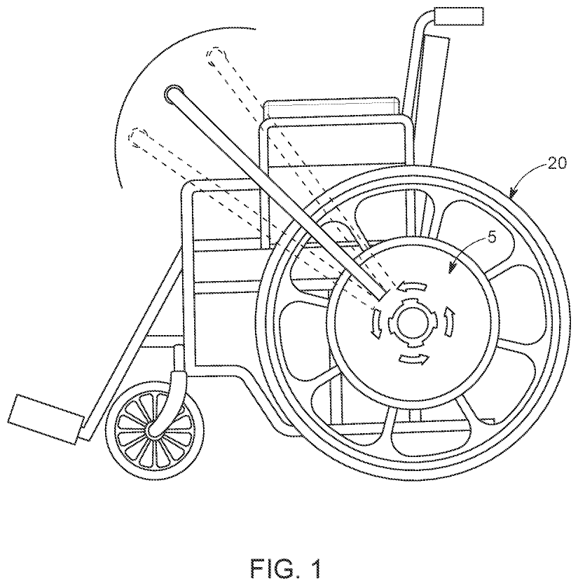

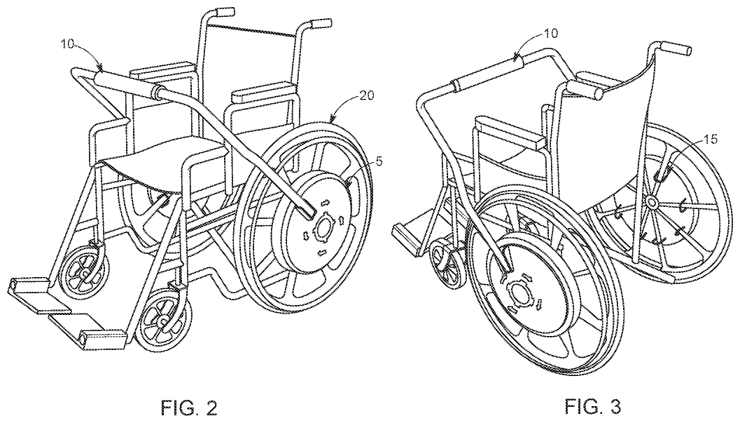

1. A wheelchair attachment for locomotion comprising of wheel adapters, adjustable handles, and spring-loaded cylindrical handle sleeve.

2. The wheelchair attachment for locomotion as in claim 1, wherein the wheel adapters are affixed to an ordinary wheelchair's wheels.

3. The wheelchair attachment for locomotion as in claim 1, wherein the adjustable handles are able to be extended or retracted to accommodate users of different sizes and to allow easier entrance and egress from the wheelchair.

4. The wheelchair attachment for locomotion as in claim 1, wherein a spring-loaded cylindrical handle sleeve is removably coupled to both adjustable handles so that the user may use both handles at the same time with a single arm.

5. A method of manufacturing a wheelchair attachment for locomotion comprising of wheel adapters, adjustable handles, and spring-loaded cylindrical handle sleeve.

6. The method of manufacturing the wheelchair attachment for locomotion as in claim 5, wherein the wheel adapters are affixed to an ordinary wheelchair's wheels.

7. The method of manufacturing the wheelchair attachment for locomotion as in claim 5, wherein the adjustable handles are able to be extended or retracted to accommodate users of different sizes and to allow easier entrance and egress from the wheelchair.

8. The method of manufacturing the wheelchair attachment for locomotion as in claim 5, wherein a spring-loaded cylindrical handle sleeve is removably coupled to both adjustable handles so that the user may use both handles at the same time with a single arm.
